(19) United States
(12) Patent Application Publication
(10) Pub. No.: US 2006/0274468 A1
(43) Pub. Date: Dec. 7, 2006

(54) Active inrush current control using a relay for AC to DC converters

(76) Inventor: Vijay Gangadhar Phadke, Pasig City (PH)

Correspondence Address: NIXON PEABODY, LLP, 401 9TH STREET, NW, SUITE 900, WASHINGTON, DC, 20004-2128, US

(21) Appl. No.: 11/144,923

(22) Filed: Jun. 3, 2005

(51) Int. Cl. H02H 3/08

(52) U.S. Cl. 361/93.1

(57) ABSTRACT

A circuit and corresponding method for controlling inrush current in an AC-DC power converter by providing a relay and a control circuit for limiting inrush current efficiently during cold startup, warm startup, and power line disturbance conditions. The relay is preferably connected in series with a bulk capacitor of the converter and in parallel with a limiting resistor and switch for shunting the resistor and switch so as to improve efficiency during operating conditions, at reduced size and cost. A preferred embodiment includes use of the circuit for AC-DC converters having active power factor correction.

### FIELD OF INVENTION

The present invention relates to controlling inrush current in a power supply, and more particularly, to circuitry for controlling inrush current efficiently during cold startup, warm startup and power line disturbance conditions.

### BACKGROUND OF THE INVENTION

The control of inrush current is especially important in N+1 redundant power systems. If excessive inrush current blows a fuse or trips the main circuit breaker on an AC distribution board, then the redundancy of the entire system is lost, even if the power supply is still functioning properly. The inrush current requirements of modern power supplies are very stringent, demanding efficient control of inrush current even during abnormal power line disturbances and for high current applications.

To control inrush current, conventional methods may employ a relay, a negative temperature coefficient (NTC) thermistor, thyristor or similar switch, often in combination with a resistor or thermistor, in an attempt to limit inrush current in an AC-DC power supply. As is known in the art, an NTC thermistor is a component with a resistance that decreases as its temperature increases. During power supply startup, the temperature of the thermistor is cold and its resistance high, a characteristic that can be used to limit inrush current. As the power supply continues to operate, the temperature increases and the resistance of the thermistor decreases, thereby allowing more current during normal operation.

FIG. 1A illustrates a prior art method and circuit disclosed in U.S. Pat. No. 5,202,819 to Min that includes a thermistor for controlling inrush current. Although the disclosed method provides inrush current control, it has major drawbacks. One drawback is that a Thermistor 6 in smoothing circuit 3 is always present as a series element, resulting in power dissipation proportional to the input current. This method is therefore inefficient especially for high current applications. In addition, if a power line disturbance (PLD) occurs during operation, the hot thermistor will be functioning at low resistance and so will not limit inrush current effectively. Thus, to prevent inrush current caused by the PLD, some delay must be built in to first allow the thermistor to cool or a circuit provided that bypasses the thermistor, in order to control inrush current.

Another drawback of the prior art circuit shown in FIG. 1A is that it uses a “Near Zero Crossing” detection for triggering two silicon controlled rectifiers (SCRs) 7,8 in the phase control rectifying circuit 5. An SCR is a device which is normally non-conducting, with conduction initiated by application of a gate current. The SCR will remain ON (i.e., conducting) until current flowing in the SCR is reduced to some minimum level. If AC power fails at a non zero phase angle, slightly higher than sensed for “Near Zero Crossing”, and recovers at the same angle after a period of one cycle, the control circuit 4 in FIG. 1A will wait for the next near zero crossing, after nearly another half AC cycle, before triggering the SCRs 7,8. A larger bulk capacitor 9 will be required to provide energy during such a power line disturbance, even when AC is restored. The result is a circuit that costs more and that has increased space requirements.

FIG. 1B shows a timing diagram that illustrates this drawback of the prior art circuit of FIG. 1A. The SCR gate drive signal waveform B shows the SCR gate drive pulses that occur at near zero phase angle. When AC fails at a non-zero phase angle, as shown in the Rectified Pulses waveform A at point A′, the SCR gate drive signal 2 will stay ON as long as energy is available on capacitor 9. If capacitor 9 has too much energy, however, there is a possibility that, due to circuit delays, the SCRs 7, 8 will trigger when AC restores at point B′. This would result in heavy inrush current. If the charge on capacitor 9 decays, then the SCR's gate drive signal 2 is unavailable at point B′ for nearly one half cycle, upon restoration of AC power, until another zero crossing occurs at point C′. As mentioned above, this problem forces use of a bigger bulk capacitor to maintain charge during the hold up period.

Another prior art method of inrush current control is disclosed in U.S. Pat. No. 5,715,154 to Rault, and shown in FIG. 2. This method has a drawback of including an extra series switch, Thyristor, 22. This extra switch will dissipate additional power; the dissipation being proportional to the input current. Thus, this method has the drawback of being very inefficient, especially for higher power applications, resulting in higher cost and the need for space-consuming heat sinking due to the increased dissipation.

FIG. 3 illustrates another conventional circuit for inrush current control. The circuit of FIG. 3 provides some inrush current control but has the drawback of not providing control during power line disturbance conditions. Modern power supply applications demand controlled inrush current even during power line disturbances that result in lost AC power. At power start up, both SCR 32 and SCR 34 in the bridge rectifier 36 shown in FIG. 3 are in the OFF state due to a lack of gate drive voltage. The initial inrush current flows through elements diode 37, diode 38, resistor 39, and diode 35 into a bulk capacitor 33 at the output of the circuit. The amount of inrush current can be kept below a desired value by choosing an appropriate value for limiting resistor 39. In operation, the Power Factor Control (PFC) boost regulator 27 starts operating by drawing power through diode 37, diode 38, and resistor 39. Bias voltage is induced in the secondary winding on the boost choke 28 due to the switching action of the boost switch 49. This induced bias voltage drives the SCRs 32,34 At that point, all power is delivered through the diode-SCR bridge.

Although the circuit of FIG. 3 can control inrush current satisfactorily for hot or cold start up conditions, the circuit has the drawback of not providing the inrush current control demanded by present generation power supplies when power line disturbances occur. Assuming an operating condition when a DC-DC converter (not shown) coupled to the output is already active and drawing power from the PFC boost regulator 27 at a low line voltage, e.g., 90V AC. If a power line disturbance occurs causing a missing AC cycle, bulk capacitor 33 at the output can continue to deliver power to the DC-DC converter during this “hold up” period. If capacitor 26 is small and cannot hold sufficient charge for driving the SCRs 32,34 during this hold up period, and if AC is restored in a time interval slightly less than the hold up time; then PFC boost regulator 27 will start switching immediately through diode 37, diode 38, and resistor 39 with most of the voltage dropped in resistor 39. This will require a longer time to generate the required gate drive for the SCRs 32,34, which results in depletion of the charge on capacitor 33. Alternatively, if capacitor 26 is made sufficiently large, the depletion problem can be solved, as the SCRs 32,34 will remain ON and can then support the required power levels of the DC-DC converter. The circuit of FIG. 3 does, however, have the drawback of not controlling inrush current at high line voltage during a power line disturbance condition. If an AC cycle is missed in a high line voltage condition, capacitor 33 will deliver the hold up power and the voltage across it will drop accordingly. In this case, the SCRs 32,34 are kept ON due to the charge available on capacitor 26. Under this condition, restoration of AC at the 90 degree phase angle and peak of 264V AC results in an undesirably large inrush current. Thus, under power line disturbance conditions, the conventional method and circuit in FIG. 3 does not control inrush current satisfactorily.

FIG. 4 illustrates another known power supply circuit 80 for inrush current control. When AC voltage is applied at the input of the power supply shown in FIG. 4, initial inrush current passes through the series resistor 39 and the bulk capacitor 33 at the output of circuit 80 is charged. After capacitor 33 is charged, resistor 39 is shunted by a switch 41 to control inrush current in this AC-DC power supply. Switch 41 shown in FIG. 4 is typically a relay or thyristor or other suitable electromechanical or semiconductor device switch. Although the circuit 80 of FIG. 4 can control inrush current satisfactorily for cold start up conditions, the circuit 80 has the drawback of not providing the inrush current control demanded by current generation power supplies when power line disturbances occur. A logic control circuit could be added to circuit 80 in an attempt to provide such inrush control. The circuit 80 of FIG. 4, however, has another drawback. If an electromechanical relay is used for switch 41, although it results in a power loss which is small, its response time would be undesirably slow. This slow response time of switch 41 would result in a circuit 80 that may not provide the inrush current control demanded by present generation power supplies during operating conditions. If a thyristor or other semiconductor switch is used for switch 41, it would have the opposite problem. The resultant power dissipation would be unacceptably high since switch 41 conducts the entire input current due to its location in the circuit 80 of FIG. 4.

FIG. 5A shows a prior art circuit 10 disclosed in commonly assigned U.S. Pat. No. 6,493,245 for controlling inrush current in an AC-DC power converter by controlling the state of a plurality of SCRs when AC power is lost. The inrush control logic circuit for power converter 10 is identified at 30. In FIG. 5A, circuit 10 comprises a bridge rectifier 40, a power factor correction boost converter 20, a level shifting circuit 50, and the inrush control logic circuit 30. As shown, circuit 10 is operatively connected between an input AC voltage (shown appearing across terminals ACL and ACN) from an AC voltage source (not shown) and an output “bulk” DC voltage appearing across terminals Bulk+ and Bulk−. The DC output bulk voltage is typically applied to the inputs of a DC-DC converter (not shown) to provide further regulation and/or voltage conversion. A pair of rectifiers D1 and D2 is connected between the AC inputs and a limiting resistor R1 and apply rectified AC pulses to R1, as shown at node 45. Diode D5 is connected in series between R1 and the positive DC Bulk voltage node terminal. Capacitor Co is connected across the DC output bulk voltage terminals.

A bridge rectifier 40 comprises diodes D3 and D4, two SCRs, SCR1 and SCR2, and two resistors R2 and R3 that are connected to respective gate terminals of the SCRs. The operation of bridge rectifier 40 and SCR1 and SCR 2 is well known in the art. The bridge rectifier output is connected at node 60 and is in parallel with R1. Node 60 is coupled to diode D5 and to the PFC circuit 20. A boost converter topology is preferably used for circuit 20. The PFC boost converter 20 is operatively connected between node 60 and capacitor Co, and preferably includes a choke inductor L1, switch Q1, two diodes D6 and D7. Switch Q1 is coupled in parallel with a series combination of diode D7 and capacitor Co. Capacitor C1 is connected across L1 and D6 of the PFC boost converter 20. C1 is also connected between node 60 and the collector of transistor Q2 in the level shifting circuit 50. The level shifting circuit 50 also includes an opto-coupler OPTO1. OPT01 is an opto-coupler package used to transmit the gate drive control signal from between the electrically isolated inrush control logic 30 and the SCRs. Transistor Q2 is a driver transistor coupled to OPTO1 which increases the current driving capacity of the signal from OPTO1 in order to control triggering of the SCRs.

The inrush control circuit 30 includes three comparators A1, A2, and A3 and corresponding control logic. The AC voltage signal at node 45 is divided by a voltage divider formed by series resistors R4 and R5 to generate a sample of instantaneous AC voltage which is applied to the negative input of comparator A1. As is known in the art, the high AC voltage level and the corresponding bulk DC voltage levels must be scaled down accordingly to provide signal levels suitable for comparison by standard comparator components. Similarly for comparator A2, the AC signal at node 45 is divided by a voltage divider formed by series resistors R8 and R9 to generate a sample of instantaneous AC voltage which is applied to the positive input of A2. The DC Bulk voltage is divided by a voltage divider formed by series resistors R6 and R7 to generate a representation of the bulk voltage which is applied to the positive input of comparator A1. A reference voltage Vref is connected to the negative input of comparator A3. Vref is also divided by a voltage divider formed by series resistors R10 and R11 and applied to the positive input of comparator A2 in order to define a threshold to set the Near Zero crossing detection for comparator A2. A suitable Vref level is chosen depending on the desired threshold. Inrush control logic 30 also includes capacitors C2, C3, and C4 for filtering and decoupling of noise, and a Zener diode DZ1 connected across R9 that protects comparator A2, as is well known in the art. The outputs of comparator A1 and A2 are connected to generate the positive input signal for comparator A3. Diode D8 couples the comparator A3 output to the level shifting circuit 50.

The operation of the circuit 10 shown in FIG. 5A will now be described in more detail. In general, circuit 10 uses a value of C1 large enough to keep both SCRs, SCR1 and SCR2, ON during the hold up time, but the inrush control circuit 30 is used to control turn ON of the SCRs. Whenever AC power is lost, during hot or cold startup or due to a power line disturbance, both SCR gates are turned OFF and are allowed to turn ON only when AC is restored and the instantaneous AC voltage is less than the bulk DC voltage at that instant. This operation eliminates the possibility of heavy inrush current for hot startup, cold startup and power line disturbance conditions. If AC restores at a peak of 264V, limiting resistor R1 takes care of the inrush current.

The detailed operation of the circuit 10 is described as follows. At power ON, initial inrush current passes through D1, D2, R1 and D5. An auxiliary supply (not shown) then begins operating to provide bias voltage to PFC boost converter 20. Switch Q1 of the PFC boost converter 20 starts switching with the DC-DC converter (not shown) still OFF. Typically the DC-DC converter is designed to start its operation when bulk DC voltage exceeds 390V. The PFC boost converter 20 is used in the AC-DC converter for both harmonic current correction and power factor correction. The signal for driving Switch Q1 is obtained from a control circuit (not shown) which varies the pulse width of a control signal that is inversely proportional to the instantaneous AC voltage. In operation, the drive pulse is wider near the bottom of the AC pulse and gradually narrower as the sinusoidal voltage increases toward its peak. This operation results in input current that is sinusoidal with a high power factor and low harmonic distortion. The drive signal provides suitable high frequency switching of Q1, e.g. in the range of between 20 kHz and several hundred kHz. As is well known in the art, high frequency switching of the PFC boost converter 20 enables reduced component size.

When Q1 of the PFC boost converter 20 is turned ON, energy is stored in inductor L1. When Q1 turns OFF, this energy is released in the output capacitor Co through D7. This switching action of Q1 develops an SCR bias voltage across capacitor C1. For continuous mode PFC operation, this bias voltage on C1 is fairly well regulated as the PFC boost converter 20 operates in flyback mode.

The control logic of the circuit in FIG. 5A for control of the SCRs to limit inrush current during hot startup, cold startup, and power line disturbance condition is now described. For the inrush control logic 30 to generate a gate control signal for triggering the SCRs, both comparators A1 and A2 must be in a high state. As seen in FIG. 5A, comparator A1 has as inputs a sample of instantaneous AC voltage and a representation of the value of the bulk DC voltage. The operation of comparator A1 ensures that the instantaneous AC voltage is less than the Bulk DC voltage on the sinusoidal rising voltage. The absence of AC voltage, however, would result in an instantaneous AC voltage which is less than the Bulk DC voltage for comparator A1. Comparator A2 is thus included to ensure that AC voltage is present. Comparator A2 compares a reference voltage, Vref, to the AC voltage at node 45. Comparator A2 is set in a high state to allow triggering of the SCRs only when AC voltage crosses a threshold of preferably about 15V. This threshold does not affect the power factor correction since the PFC boost converter 20 starts boosting action from approximately 35V.

The operation of comparator A2 to ensure AC is present is important since if only comparator A1 was used, SCRs would remain ON in the case of a missing AC cycle which would result in huge inrush current upon restoration of AC to its peak value. This condition is to be avoided since it could be uncontrollable, as commutation of SCRs will be very difficult. In operation, if input AC restores at some non-zero phase angle, and at that instant, if peak voltage is higher than bulk voltage, then the SCRs are held OFF. The SCRs remain held off until the instantaneous AC voltage falls below the bulk DC voltage while traversing the sinusoidal path. Only then are the SCRs allowed to trigger. This operation is illustrated by the waveforms in FIG. 4B which is described in detail below. This operation of the circuit overcomes the drawbacks of methods which fail to limit inrush current reliably and efficiently in the case of power line disturbances.

Comparator A3 is set to a high state only when the outputs of comparators A1 and A2 are both set to a high state. This operation ensures both that AC is present and that instantaneous AC voltage is less than the bulk DC voltage. Diode D8 couples the output of comparator A3 to the level shifting circuit 50. The level shifting circuit 50 is required since the inrush control logic 30 generates a low side control signal that must be level shifted to a high drive signal in order to drive the gate of the SCRs to control triggering. OPTO1 is an opto-coupler package which is necessary for transmitting the signal between the electrically isolated inrush control logic 30 and SCR circuits. Transistor Q2 is a driver transistor coupled to OPTO1 which increases the current driving capacity of the signal from OPT01 in order to control triggering of the SCRs.

FIG. 5B is a timing diagram illustrating the SCR gate drive signal timing during a missed AC cycle for the circuit in FIG. 5A. A gate drive pulse is applied to the SCRs only when instantaneous AC voltage is non zero and lower than the bulk DC voltage. When AC voltage fails at a non-zero phase angle, as shown for the rectified pulses in Trace D, the SCR gate drive signal, as shown in Trace E, will be kept low. Bulk voltage will continue to decay as shown in Trace C, while supplying energy to the DC-DC converter during the hold up period. When AC voltage restores at a non zero phase angle, the SCR drive signal is held low until the instantaneous AC voltage falls below the bulk DC voltage as shown, which prevents the huge inrush current that would otherwise result. By contrast, for the FIG. 1 prior art method, as seen in FIGS. 1A and 1B, a bulk capacitor must provide hold up power until the next zero crossing point even after AC is restored.

A drawback of the circuit 10 in FIG. 5A is that this circuit uses a greater number of parts due to usage of a discrete bridge rectifier using SCRs. The circuit 10 has the additional drawback of presenting substantial challenges in packaging high density power supplies because of the relatively large size of the discrete four device bridge rectifier in circuit 10, especially as compared to a modular bridge rectifier.

FIG. 6A shows a prior art circuit disclosed in commonly assigned U.S. Pat. No. 6,714,429 for providing active inrush current control of an AC-DC power converter 100. The inrush control circuit for power converter 100 is identified at 110. Converter 100 includes a bridge rectifier 94, a boost converter 120, inrush control circuit 110, and additional control circuitry as shown in FIG. 6A. Converter 100 is operatively connected between an AC input voltage (shown appearing across terminals ACL and ACN) from an AC voltage source (not shown) and an DC bulk output voltage appearing across terminals “Bulk+” and “Bulk-”. The DC bulk output voltage is typically applied to the inputs of a DC-DC converter (not shown) to provide further regulation and/or voltage conversion. The AC input voltage is coupled to a bridge rectifier 94. The bridge rectifier 94 comprises diodes 37, 38, 42, and 43. The operation of bridge rectifier 94 is well known in the art. The bridge rectifier output is coupled to node 142 to provide rectified AC pulses to the circuit as shown. Node 142 is coupled to a diode 138 and to the boost converter 120.

As shown in FIG. 6A, boost converter 120 is operatively connected between node 142 and capacitor 33. Boost converter 120 preferably includes an inductor 52, a diode 48 and a switch 98. Inductor 52 and diode 48 are connected in series between node 142 and the positive Bulk output voltage node terminal (Bulk +). Switch 98 is connected between a node, intermediate to inductor 52 and diode 48, and the negative bulk output voltage node terminal. Switch 98 is an n-channel MOSFET having a source, drain and gate. Switch 98 is controlled by application of a suitable waveform to its control gate. The gate drive signal, preferably controlled for power factor correction, is provided for control of switch 98 of the boost converter 120. This gate drive signal is identified as “PFC DRIVE” in FIG. 6A. A suitable PFC control circuit may be used to provide the PFC Drive signal for achieving power factor correction (details not shown, PFC being well known to one of ordinary skill in the art).

The series combination of bulk capacitor 33 and inrush limit resistor 92 is connected across the DC bulk output voltage terminals. A switch 119 is coupled in parallel with inrush limit resistor 92. Switch 119 is preferably a MOSFET. Alternatively, a bipolar transistor, IGBT or any suitable semiconductor device may be used for switch 119. A resistor 108 is connected in series between inrush control circuit 110 and the gate of MOSFET switch. The inrush control circuit 110 will now be described in more detail.

The inrush control circuit 110 includes a comparator circuit preferably including five comparators (identified as 62, 64, 66, 102, and 114 in FIG. 6A) and additional control circuitry. The AC rectified pulses signal at node 142 is connected to the inrush control circuit 110 through its input node 143. The AC rectified pulses signal at node 142 are divided in inrush control circuit 110 by a voltage divider formed by series resistors 63 and 65 to generate a sample of instantaneous AC voltage which is applied to the negative input of comparator 62. As is known in the art, the high AC voltage level and the corresponding DC bulk output voltage levels must be scaled down accordingly to provide signal levels suitable for comparison by standard comparator components. Similarly, for comparator 64 the AC rectified pulses signal at node 142 is divided by a voltage divider formed by series resistors 68 and 69 to generate a sample of instantaneous AC voltage which is applied to the positive input of comparator 64. The DC bulk output voltage is divided by a voltage divider formed by series resistors 67 and 61 to generate a representation of the bulk output voltage which is applied to the positive input of comparator 62.

A reference voltage, identified as “VRef” in FIG. 6A, is coupled to the negative input of comparator 66. VRef is also divided by a voltage divider formed by series resistors 71 and 73 and applied to the positive input of comparator 64 in order to define a threshold to set the Near Zero crossing detection for comparator 64. A suitable VRef level is chosen depending on the desired threshold and is preferably a 5V reference. Capacitors 72, 74, and 76 are connected in parallel with resistor 65, 61, and 69 respectively, for the filtering and decoupling of noise. The outputs of comparators 62 and 64 are connected at a node 82 which is coupled to the positive input for comparator 66.

An internal auxiliary converter (not shown) generates a bias voltage Vcc for the inrush control circuit 110 shown in FIG. 6A. Resistor 77 is connected in series between Vcc and node 82. The output of comparator 66 is connected to node 112. Resistor 122 in connected in series between Vcc and node 112. A parallel combination of diode 123 and resistor 126 couples the comparator 66 output to the positive input for comparator 114 at node 116. Node 116 is located at the junction of the positive input for comparator 114, the cathode of diode 123, resistor 126, and capacitor 115. Resistor 126, capacitor 115, and diode 123 form an RCD network for the positive input of comparator 114. Capacitor 115 couples node 116 to the negative bulk output voltage terminal to provide signal filtering. A resistor 124 is connected in series with a capacitor 113 between node 112 and the negative bulk output voltage terminal. The resistor 124 is connected in parallel with a diode 121 between node 112 and the positive input terminal of comparator 102 at node 144. Node 144 is located at the junction of the positive input for comparator 102, the anode of diode 121, resistor 124, and capacitor 113. A series combination of resistors 128 and 132 is coupled between the output of comparator 102 and the negative input of the comparator 114. Node 146 is located at the junction of the negative input of the comparator 114 and resistor 132, and is connected to VREF.

Inrush control circuit 110 in FIG. 6A also includes a transistor 118. Transistor 118 is preferably a pnp-type transistor having a base, emitter, and collector, though any suitable transistor can be used. Node 146 is connected to the emitter of a transistor 118. The junction of resistors 128 and 132 connects to the base of the transistor 118. A resistor 134 is connected in series between the collector of transistor 118 and a “PFC DRIVE OFF” node as shown in FIG. 6A. The signal at the “PFC DRIVE OFF” node provides hold off of the gate signal (shown preferably as PFC Drive in FIG. 6A) coupled to the gate of switch 98, thereby holding off switching of switch 98. A resistor 136 is connected in series between the output of comparator 114 and the VCC. The output of comparator 114, at node 148, is coupled via an output node 141 to the resistor 108 which is connected to the gate of MOSFET switch 119 for switching control.

The operation of the active inrush current control circuit of FIG. 6A will now be described in further detail. At initial power on, the entire controlled inrush current will pass through the diodes 37, 38, 42 and 43 of bridge rectifier 94, inductor 52, diode 48, capacitor 33 and inrush limit resistor 92. Alternatively, a bypass diode 238 is connected across the series combination of inductor 52 and diode 48 to avoid saturation of inductor 52. Soon after initial power on, an internal auxiliary converter (not shown) starts up and generates the bias voltage Vcc for the inrush control circuit 110. Whenever AC cycles are missed in operating conditions due to power line disturbances, inrush control circuit 110 causes switch 119 to turn off. The bulk capacitor 33 will continue to hold up the bulk output voltage being fed to the DC-DC converter during the hold up period. Upon restoration of AC, a high inrush current can flow if the peak of the AC voltage is greater than the bulk output voltage at that point. However as the switch 119 is in off state, this current passes through bulk capacitor 33 and limiting resistor 92. Switch 119 is allowed to turn on only when favorable conditions are attained. Further details of the inrush control circuit 110 will now be discussed.

For the inrush control circuit 110, the comparators 62 and 64 set two conditions which must be satisfied to cause switch 119 to turn on. If the device used for switch 119 does not have a body diode as found in the MOSFET shown in FIG. 6A, an external diode must be connected across the device. Comparator 62 is connected such that the output is high for the condition wherein the instantaneous AC voltage at node 142 at the given time is lower than the bulk output voltage at that time. Comparator 64 is connected such that the AC rectified voltage at node 142 must be present and non-zero in order for the output to be set high (active). A non-zero detection threshold of 15V is preferred since it is readily sensed and does not affect the power factor and other performance since typically the PFC controlled boost converter stage becomes active at about a 35V level.

The operation of comparator 64 ensures that switch 119 always stays in the off state during missing cycle conditions, since at that time the AC input voltage is zero (not non-zero). Comparator 66 performs an AND operation such that its output goes high only when the above described conditions set by both comparators 62 and 64 are satisfied. In operation, a resistor 77 and capacitor 111 provide a small delay at the inputs to comparator 66. This delay is introduced in order to eliminate a race condition at the inverting and non-inverting pins of comparator 62 when AC voltage restores at a 90 degree phase and at very high dV/dT.

During a missing cycle, the condition set by comparator 64 is not satisfied and thus the output of comparator 66 goes low. As a result, the output of comparator 102 goes low rapidly due to the RCD network comprising resistor 124, capacitor 113, and diode 121 connected at the non inverting input of comparator 102. Diode 121 has an anode connected to capacitor 113 and a cathode connected to the output of comparator 66. Because of this orientation of diode 121, the capacitor 113 discharges quickly whenever the output of comparator 66 goes low. As a result, the PNP transistor 118 becomes forward biased and the 5V high VRef signal is developed at its collector. This signal at the collector of transistor 118 is coupled to the PFC DRIVE OFF node as shown in FIG. 6A for use in holding off the PFC Drive signal which in turn holds off switching of switch 98. Different signals can be developed from the basic signal from the collector of transistor 118 in order to turn OFF the boost converter stage, depending upon the particular control circuit used for control of the PFC Drive signal.

The parallel combination of diode 123 and resistor 126 are connected in series between the output of comparator 66 and the positive input of comparator 114. Diode 123 has an anode connected to comparator 66 and a cathode connected to the positive input of comparator 114. Thus, diode 123 is oriented opposite to diode 121 with respect to the output of comparator 66 and their respective comparator inputs. When the output of comparator 66 goes low, capacitor 115 will discharge after some time predetermined by the values of resistor 126 and capacitor 115. The output of comparator 114 then goes low, turning off the switch 119. The inrush control circuit thus ensures that the PFC Drive is switched off (holding off switch 98 of the boost converter 120) before switch 119 turns off.

When the AC voltage restores at a non zero angle, e.g. 90 degree phase angle near its peak, comparator 62 will not permit the drive of either the switch 98 or the switch 119 to go high unless the instantaneous AC voltage on the rectified pulse at node 142 falls below the bulk output voltage level. When this condition has not occurred, the switch 119 is off and the current that flows through the bulk capacitor 33 is controlled by series limiting resistor 92. The DC to DC converter (not shown) can then draw power directly from the bridge rectifier 94 to continue its operation. When instantaneous AC level does fall below the bulk level, output of comparator 66 goes high. Due to the configuration of the input RCD networks for both comparator 102 and comparator 114, the circuit in FIG. 6A ensures that the output of comparator 114 goes high first, turning on the switch 119 before the output of comparator 102 goes high. At that time, no current flows through switch 119 because the bridge rectifier 94 is reverse biased. After a short delay determined by the RCD network for the input to comparator 102, the comparator 102 output goes high which results in the PFC DRIVE OFF signal causing removal of the hold off on the PFC Drive signal, thus enabling switch 98 of the boost converter to be switched on. The circuit in FIG. 6A has the advantage of eliminating the large surge in voltage seen on the bulk capacitor 33. Once the hold off on the PFC drive is removed, normal operation of the converter is restored.

FIG. 6B shows a timing diagram illustrating the operation of the circuit in FIG. 6A for the operating condition where there are missing AC cycles and the AC voltage recovers at a 90 degree phase angle near its peak. For FIG. 6B, Trace F represents the rectified AC pulses; Trace G is the input current; Trace H is the bulk output voltage; Trace I is the gate control signal for switch 98 (preferably the PFC Drive signal); and Trace J is the gate drive signal for switch 119.

The circuit shown in FIG. 6A meets the requirements of active inrush control, however, the circuit requires the switch 119 to be rated to handle a current surge when a differential pulse is applied at the input during EMC and Immunity testing. The result is a circuit that has higher cost. Another drawback of the circuit shown in FIG. 6A is that the ripple current of the capacitor 33 is continuously handled by the switch 119 such that considerable power is lost, particularly at low line voltage. The result is a circuit that has less efficiency and increased thermal requirements in high power designs.

What is needed is lower cost and more efficient circuit and corresponding method for providing the inrush current control demanded by current generation power supplies during hot and cold startup conditions and when power line disturbances occur.

What is also needed is a circuit and corresponding method for providing inrush current control that does not require the switch connected in series with the bulk capacitor to be rated to handle the current surge when a differential pulse is applied at the input during EMC and Immunity testing, so as to enable use of a lower cost series-connected switch.

### SUMMARY OF THE INVENTION

The present invention solves the problems of prior art devices by providing a circuit and corresponding method which provides control to limit inrush current during cold startup, hot startup and power line disturbance conditions in AC to DC converters.

Broadly stated, the present invention provides an AC to DC power converter having active inrush current control during operational and power disturbance conditions, the converter having two input terminals to which AC power is coupled and two output terminals where the output DC power is provided, comprising an input rectifier for generating a rectified input voltage from a source of the AC power; a boost converter coupled to the rectifier for converting the input voltage to a DC voltage, the boost converter having a first switch, an inductor, and a first diode; an output capacitor connected to a first one of the DC output terminals; a resistor connected in series between the output capacitor and a second one of the DC output terminals; a second switch having a control input and being connected in parallel with the resistor; a first control circuit operatively connected to the control input of the second switch for comparing the AC input and DC output voltages of the converter for causing the second switch to enter a conduction state when the AC input voltage exceeds a predetermined threshold and the AC input voltage is less than the DC output voltage; a relay connected in parallel with the resistor and the second switch and having control input; and a second control circuit operatively connected to the control input of the relay for causing the relay to enter a conduction state to shunt the second switch and the resistor when the DC output voltage exceeds the peak of the AC input voltage for a predetermined time.

The present invention broadly stated also provides a method of controlling inrush current in a AC-DC converter when AC power is lost during power line disturbance conditions, wherein the AC to DC converter is coupled between two input terminals to which AC power is coupled and two output terminals where the DC output voltage is provided, the AC-to DC converter including a boost converter controlled by a first switch, the AC to DC converter having connected across the output terminals a capacitor connected in series with the combination of a limiting resistor connected in parallel with a second switch, and a relay having a control input and connected in parallel with the limiting resistor and the second switch, comprising the steps of a) Causing the first switch to be in an off state when the AC power is lost for a predetermined time interval; b) Causing the relay to switch the relay contact to an open state a predetermined time after the first switch is switched to the off state; c) Causing the second switch to be in an off state substantially simultaneously with the switching of the relay contact to the open state in step b); d) Comparing the instantaneous AC input voltage to the DC output voltage of the converter; e) Comparing the instantaneous AC input voltage to a predetermined voltage level to determine if the AC input voltage is present and non-zero; f) Causing the second switch to be in an on state when the AC power is restored to the predetermined voltage level and the instantaneous input AC voltage is less than the DC voltage at the output of the AC-DC converter; g) Causing the second switch to be in an off state when the AC power is restored to the predetermined voltage level and the instantaneous input AC voltage is greater than the DC voltage at the output of the AC-DC converter; and h) Causing the relay to switch the relay contact to a closed state to shunt the second switch and the limiting resistor a predetermined time after the AC power is restored to the predetermined voltage level and the DC voltage at the output of the AC-DC converter is greater than the instantaneous input AC voltage, such that inrush current is controlled and voltage surges at the DC output terminals are eliminated.

Consequently, the circuit and corresponding method of the present invention has the advantage that inrush current is controlled for startup conditions, and even when power line disturbance conditions occur, and provide the required control without undesirable voltage surges at the output.

Another advantage of the present invention is improved efficiency as the current of the bulk capacitor is not continuously handled by the switch during standard operating conditions, i.e., conditions other than cold startup, warm startup, and power line disturbance conditions, thus reducing power loss. Another advantage of the present invention is that inclusion of a relay along with the control circuit enables use of a lower cost and smaller series-connected switch since the switch need not be rated to handle a current surge when a differential pulse is applied at the input during EMC and Immunity testing.

### BRIEF DESCRIPTION OF THE DRAWINGS

The forgoing aspects and the attendant advantages of the present invention will become more readily appreciated by reference to the following detailed description, when taken in conjunction with the accompanying drawings, wherein:

FIG. 1A shows a prior art circuit that includes a thermistor for controlling inrush current;

FIG. 1B shows a timing diagram illustrating a drawback of prior art circuit of FIG. 1;

FIG. 2 depicts another prior art method of inrush current control that includes an extra series dissipative switch;

FIG. 3 illustrates another prior art circuit that provides some control of inrush current at startup but not during power line disturbances;

FIG. 4 shows a prior art circuit that includes a switch at the input for controlling inrush current;

FIG. 5A shows a prior art circuit for controlling inrush current in an AC-DC power converter by controlling the state of a plurality of SCRs when AC power is lost;

FIG. 5B is a timing diagram illustrating the SCR gate drive signal timing during a missed AC cycle for the circuit in FIG. 5A;

FIG. 6A shows another prior art circuit for providing active inrush current control;

FIG. 6B shows a timing diagram illustrating the operation of the circuit in FIG. 6A for the operating condition where there are missing AC cycles and the AC voltage recovers at a 90 degree phase angle near its peak;

FIG. 7A shows a circuit diagram of a preferred embodiment of an AC-DC power converter according to the present invention;

FIG. 7B shows a timing diagram illustrating the operation of the circuit in FIG. 7A for the operating condition where there are missing AC cycles and the AC voltage recovers at a 90 degree phase angle near its peak;

FIG. 8 shows a circuit diagram illustrating an alternative embodiment of a according to the present invention for providing inrush current control only during AC power up; and

FIG. 9 shows a circuit diagram of a preferred embodiment of a relay drive circuit according to the present invention.

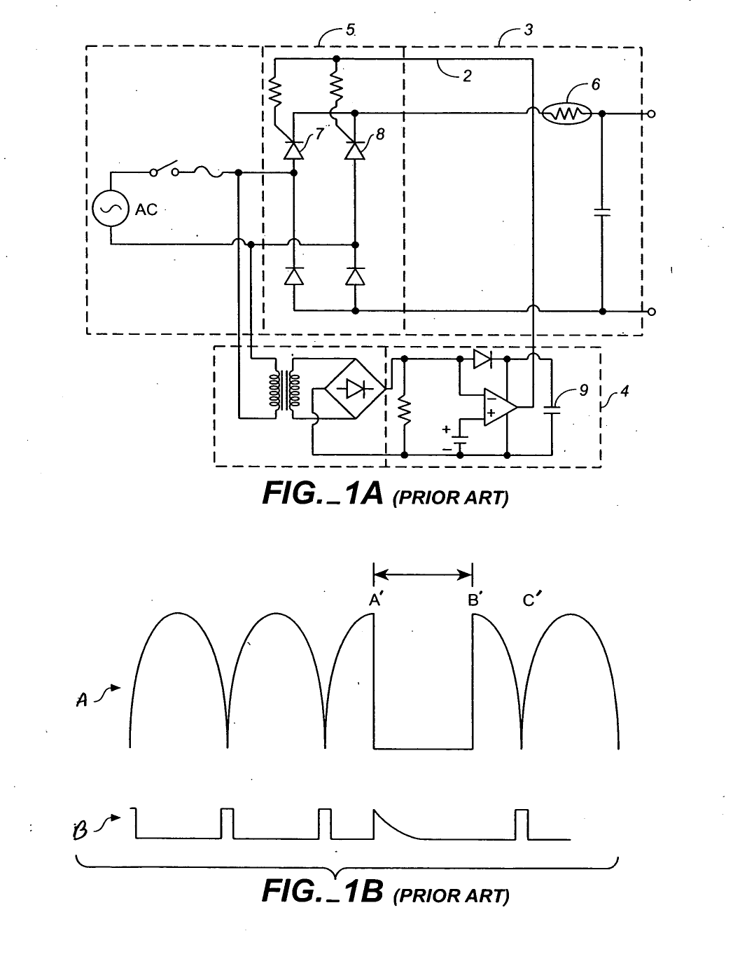

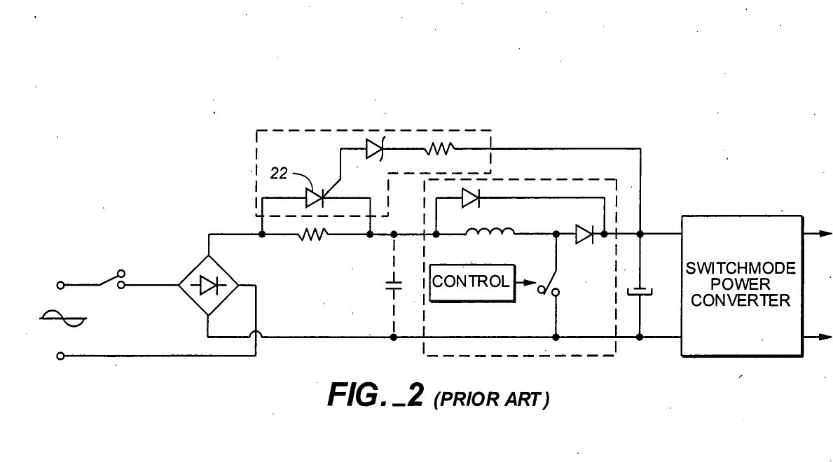

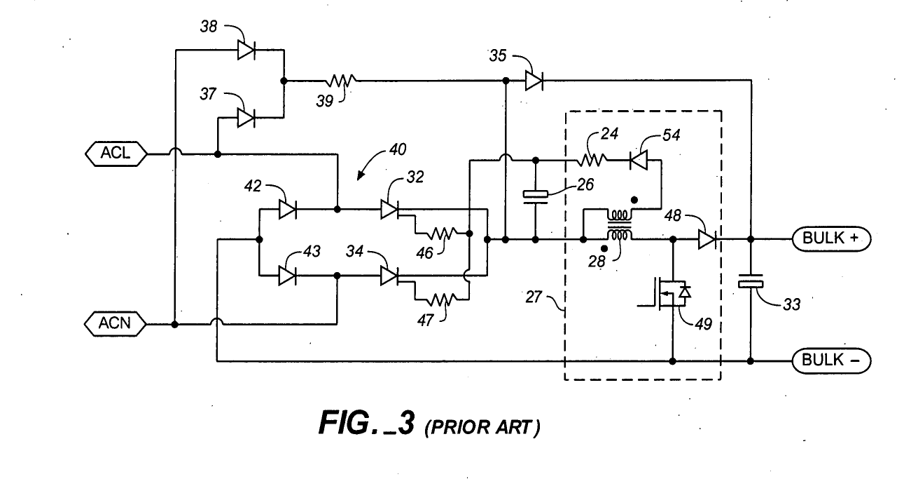

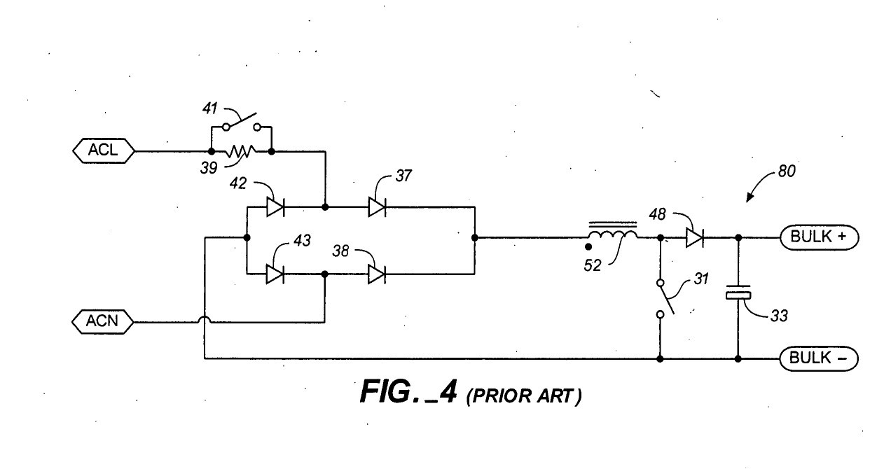

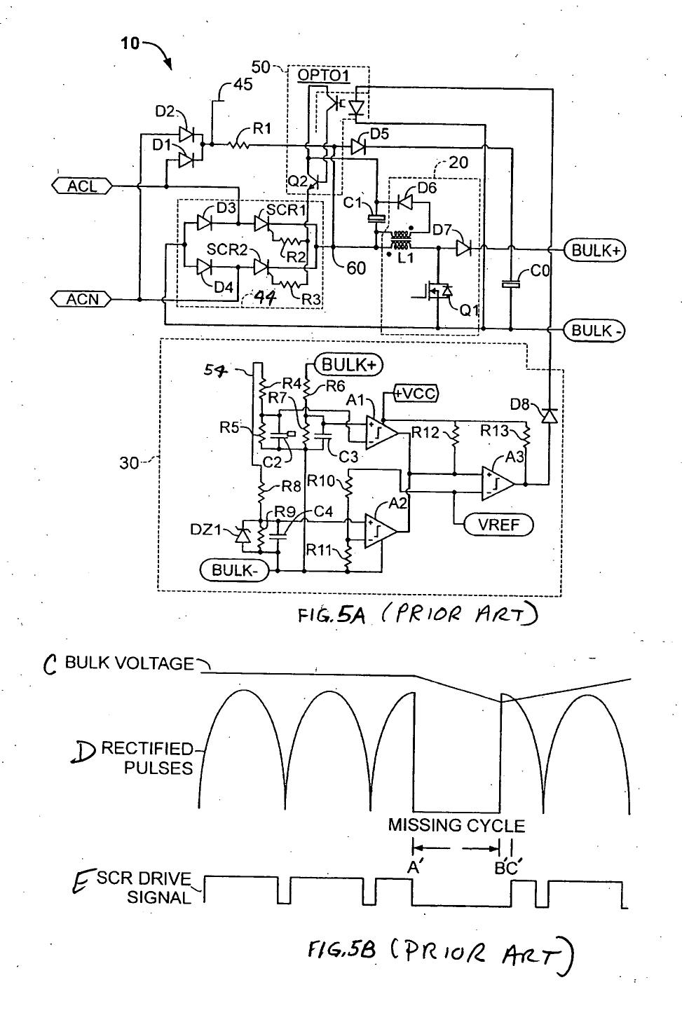

### DETAILED DESCRIPTION OF THE INVENTION

The present invention comprises a circuit and corresponding method which provides control to limit inrush current during cold startup, hot startup and power line disturbance conditions in AC to DC power converters. The present invention overcomes the drawbacks of the known circuits and methods. The present invention will now be described in further detail.

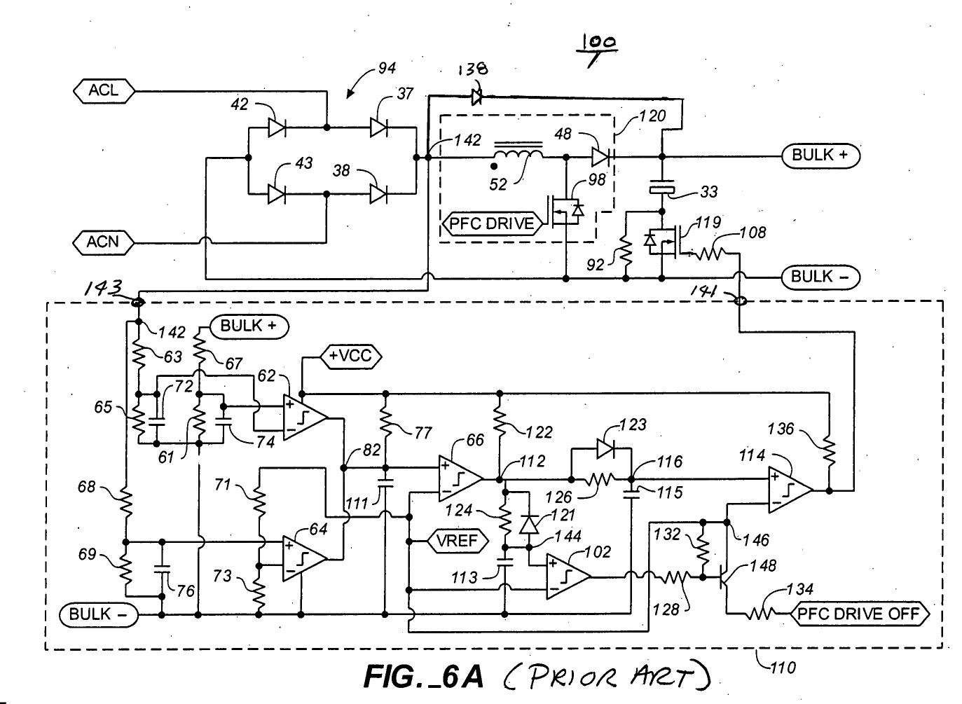

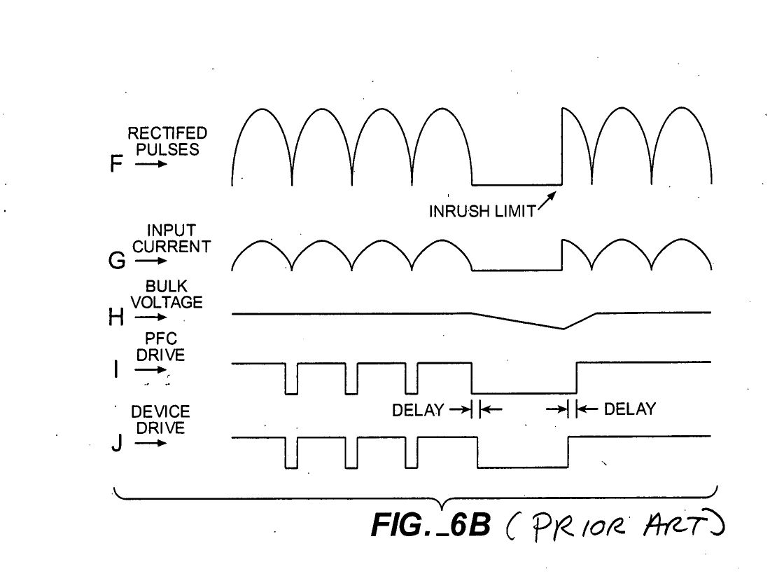

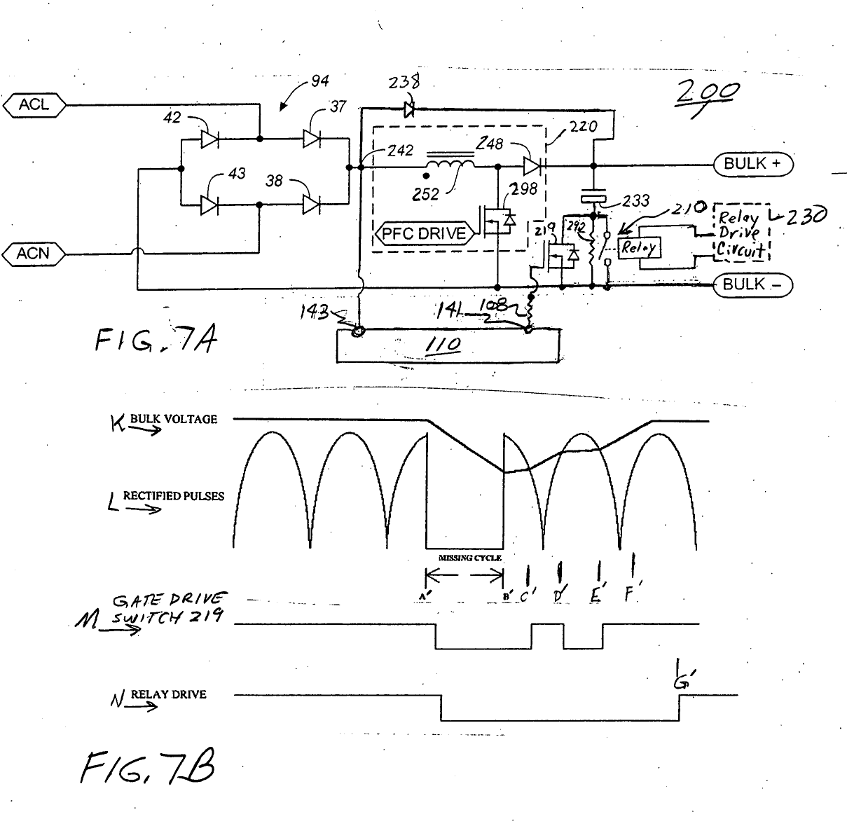

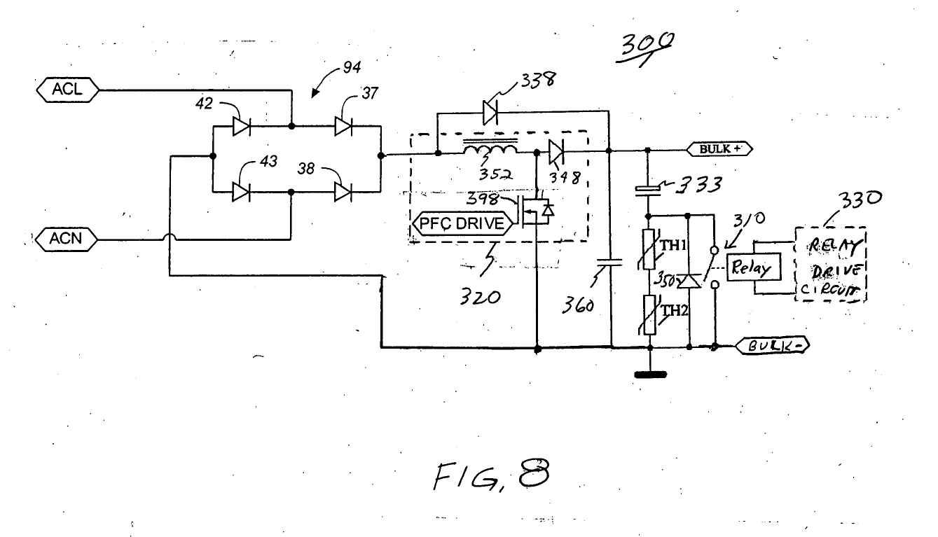

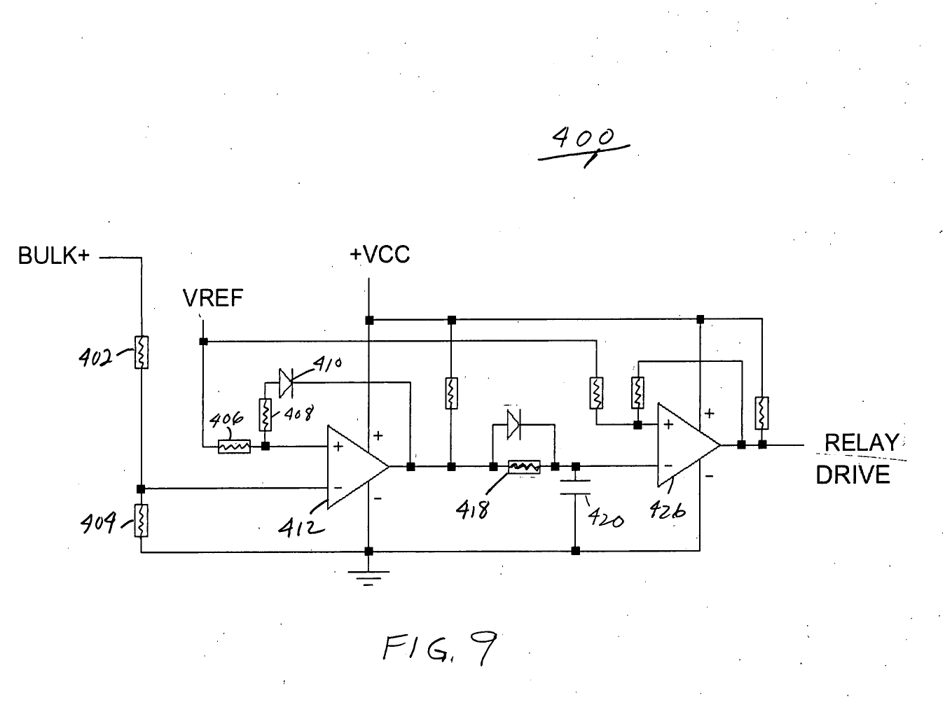

FIG. 7A shows a circuit diagram of a preferred embodiment of an AC-DC power converter 200 according to the present invention. Converter 200 is operatively connected between an AC input voltage (shown appearing across terminals ACL and ACN) from an AC voltage source (not shown) and an DC bulk output voltage appearing across terminals “Bulk+” and “Bulk-”. The DC bulk output voltage is typically applied to the inputs of a DC-DC converter (not shown) to provide further regulation and/or voltage conversion. The AC input voltage is coupled to a bridge rectifier 294. The bridge rectifier 294 comprises diodes 237, 238, 242, and 243. The operation of bridge rectifier 294 is well known in the art. The bridge rectifier output is coupled to node 242 to provide rectified AC pulses to the circuit as shown. Node 242 is coupled to a diode 238 and to a boost converter 220. According to the preferred embodiment shown in FIG. 7A, the AC rectified pulses signal at node 242 are connected to the inrush control circuit 210 through its input node 243, wherein the operation of inrush control circuit 210 is comparable to the operation of inrush control circuit 110 shown in FIG. 6A.

As shown in FIG. 7A, boost converter 220 is operatively connected between node 242 and a capacitor 233. Boost converter 220 preferably includes an inductor 252, a diode 248, and a switch 298. Inductor 252 and diode 248 are connected in series between node 242 and the positive Bulk output voltage node terminal (Bulk +). Switch 298 is connected between a node, intermediate to inductor 252 and diode 248, and the negative bulk output voltage node terminal. Switch 298 is preferably a MOSFET having a source, a drain and a control gate terminal. Switch 298 is controlled by application of a suitable waveform to its control gate terminal. The gate drive signal, preferably controlled for Power Factor Correction (PFC), is provided for control of switch 298 of the boost converter 220. This gate drive signal is identified as “PFC Drive” in FIG. 7A. A suitable PFC control circuit may be used to provide the PFC Drive signal for achieving power factor correction (details not shown, PFC being well known to one of ordinary skill in the art).

The series combination of bulk capacitor 233 and a resistor 292, also referred to as an inrush limit resistor, is connected across the DC bulk output voltage terminals. A switch 219 is coupled in parallel with inrush limit resistor 292. Switch 219 is preferably a MOSFET having a source, a drain and a control gate terminal. Alternatively, a bipolar transistor, IGBT or any suitable semiconductor device may be used for switch 219. Switch 219 is controlled by application of a gate drive signal to its control gate terminal. Preferably, an output of inrush control circuit 210 in FIG. 7A comparable to control circuit 110 in FIG. 6A at output node 241 is coupled via a resistor 208 to the control gate terminal of switch 219.

A relay 240 is coupled in parallel with switch 219 and the inrush limit resistor 292. A relay drive circuit 230 provides a suitable control signal for switching the relay 240 on and off.

The operation of the converter of FIG. 7A will now be described in further detail. At initial power on, the entire controlled inrush current will pass through the diodes 237, 238, 242 and 243 of bridge rectifier 294, inductor 252, diode 248, capacitor 233, and inrush limit resistor 292. Alternatively, a bypass diode 238, as seen in FIG. 7A, is connected across the series combination of inductor 252 and diode 248 to avoid saturation of inductor 252.

Soon after initial power on, capacitor 233 charges to a suitable level causing an internal auxiliary converter (not shown) to start up and generate the bias voltage Vcc for the inrush control circuit 210 in FIG. 6A. Capacitor 233 provides energy to the internal auxiliary converter through the body diode of switch 219. The bias voltage Vcc is caused to reach a desired level for energizing the inrush control circuit 210. Further details regarding the operation of the inrush control circuit 210 are as discussed above regarding the inrush control circuit 110 shown in FIG. 6A. The inrush control circuit 210 causes switch 219 in FIG. 7A to turn on if two conditions are both met. Comparator 62 in FIG. 6A is connected such that the output is high for the first condition wherein the instantaneous AC voltage at node 242 at the given time is lower than the bulk output voltage at that time. Comparator 64 in FIG. 6A is connected for the second condition such that the AC rectified voltage at node 242 must be present and non-zero in order for the output to be set high (active). A non-zero detection threshold of 15V is preferred since it is readily sensed and does not affect the power factor and other performance factors since typically the PFC controlled boost converter stage becomes active at about a 35V level.

After switch 219 is caused to be turned on by the inrush control circuit 210, the PFC DRIVE signal causes the boost converter 220 to turn on and start boosting the rectified input pulses at node 242. The PFC DRIVE signal is controlled such that the operation of the boost converter 220 is enabled only after switch 219 has been turned on so as to prevent large voltage transients which can occur, due to the series impedance of resistor 292 for capacitor 233, if boost converter 220 starts switching during the time when switch 219 and the relay 240 are both off.

The relay drive 230 causes the relay 240 to be closed allowing a DC/DC converter (not shown) connected to the output of converter 200 to turn on once the boost voltage stabilizes after entering the regulation band. The closing of the contact of relay 240 causes all charging and discharging current of capacitor 233 to pass through the closed contact of relay 240 instead of through the on-state resistance of switch 219, so as to substantially reduce the power dissipation.

If the input AC cycles are missed, so that AC fails for a short duration in operating conditions due to power line disturbances, for instance, the inrush control circuit 210 senses the failure quickly (typically <1 milliseconds) and sets a PFC DRIVE OFF signal, of the type shown in FIG. 6A, so as to disable switching of the boost converter 220. After a short delay, the contact of relay 240 is caused to be opened by the relay drive 230 and at about the same time, inrush control circuit 210 causes switch 219 to turn off. As described above, the relay 240 and switch 219 are not permitted to both be off during the switching of the boost converter 220 in order to prevent the large voltage transients that would otherwise occur. The short delay after switching of the boost converter 220 is disabled allows inductor 252 to be discharged into capacitor 233. After the short delay, switch 219 can be turned off and the contact of relay 240 opened. The duration of the short delay is a function of the design and operating frequency of the inductor 252 and is typically in the range of 50 to 100 microseconds, i.e., 0.05-0.1 milliseconds. The whole cycle from AC failure to relay turn off may take up to approximately 5 milliseconds due to a period of up to about 2 ms for sensing the AC failure, the short delay, and the turn off period for the relay contact of up to 2 milliseconds. A large inrush current is not expected if the input AC voltage is restored during the approximately 5 millisecond interval because the bulk voltage level will be quite high.

The instantaneous value of the AC input is compared with the bulk level by the inrush control circuit 210 whenever the AC input restores during a valid hold up time. Switch 219 is caused to be turned on, after which the PFC DRIVE is enabled for boosting, only if the two conditions described above are met.

During restoration of the input AC voltage, as the bulk voltage is recovering to its operating level, it is common to see switch 219 turning on and off at several points of the AC sine wave half cycle, whenever the AC voltage transitions and exceeds the bulk voltage level. For example, if the bulk voltage has discharged up to 300V and the AC input voltage restores at the peak of 265V RMS, switch 219 will be held in an off state until the AC input voltage falls below the 300V level along its downward sinusoidal path so as to meet the two above conditions for turning on switch 219. After switch 219 is caused to be turned on by the inrush control circuit 210, the PFC DRIVE signal causes the boost converter 220 to turn on and start boosting the rectified input pulses at node 242.

The bulk voltage may not go back to its desired regulated level for several of these cycles, so switch 219 will actively turn on and off whenever the inrush control circuit 210 senses the possibility of inrush current. The relay contact of relay 240 is turned on by the relay drive 230 after a short delay, typically 50 milliseconds, after the bulk voltage enters regulation.

FIG. 7B shows a timing diagram illustrating the operation of the circuit in FIG. 7A for the exemplary operating condition where there are missing AC cycles and the AC voltage recovers at a 90 degree phase angle near its peak. Trace K is the bulk voltage at the output, Trace L shows the rectified pulse at the output of the bridge rectifier, Trace M is the gate drive signal for switch 219, and Trace N is the relay drive signal 230 for controlling the relay 240. When the AC rectified pulses fail, at point A′, the inrush control circuit 110 causes switch 219 to be turned off quickly and, after a short delay, the relay drive 230 causes the contact of relay 240 to open.

The inrush control circuit 210 continues to keep switch 219 off even after the AC voltage is restored at point B′ and up to point C′ since the AC voltage is higher than the bulk voltage. During this interval, the DC/DC converter (not shown) connected to the output of converter 200 is powered from the line voltage directly while capacitor 233 gets charged through resistor 292. At point C′, the instantaneous AC input voltage falls below the bulk voltage level, thus satisfying the conditions required for inrush control circuit 110 to cause switch 219 to turn on.

As seen in FIG. 7B, the drive signal for switch 219 will cause switch 219 to turn off at point D′ since the instantaneous AC input voltage exceeds the bulk voltage level. At point E′, the drive signal causes switch 219 to turn on again since the instantaneous AC input voltage falls below the bulk voltage level, As seen in FIG. 7B, at point F′, the switch 219 is held on since the instantaneous bulk voltage has risen higher than the peak of the AC input voltage.

As discussed above, relay 240 is turned on at point G′, a predetermined delay time after the turn on of switch 219 at point E′. The delay allows the circuit to stabilize. Switch 219 receives the charging and discharging current of capacitor 233 during this delay period, but there is no significant heat dissipation. The inventors have demonstrated for an exemplary 2.5 Kw converter according to the embodiment in FIG. 7A, that the heat dissipation for the switch, e.g., a T0220 sized flat pack device, was of such insignificance that a heat sink was not required.

The converter 100 in FIG. 6A has a drawback of substantial power loss during normal operating conditions, i.e., when the voltage is in regulation and not in a startup or failure condition, caused by the switch 119 in series with capacitor 33. In the converter of present invention shown in FIG. 7A, switch 219 is shunted by the relay contact of relay 240 during such normal operating conditions such that power loss, e.g., due to loss in switch 219, is eliminated and efficiency thereby increased. As a result, converter 200 has advantages of reduced power loss and greater efficiency as compared to the converter in FIG. 6A and other known converters.

The present invention has the advantage that inrush current is controlled at reduced cost. The present invention can be used in all AC-DC converters, with or without power factor correction. Another advantage of the converter 200 is improvement of as much as 0.6% for a low line voltage as compared to converter 100 in FIG. 6A, since the current of capacitor 233 is not continuously handled by switch 219 during normal operating conditions. That is, the power loss is reduced as compared to the losses caused by switch 119 in the converter shown in FIG. 6A. Since the relay 240 is placed in series with the capacitor 233, the current rating of the contact of the relay only needs to handle the RMS ripple current of capacitor 233, thus enabling use of a smaller relay.

Another advantage of the converter 200 is that the use of relay 240 in series with capacitor 233 and in parallel with the switch 219, enables use of a lower cost switch 219 since switch 219 need not be rated to handle a current surge when a differential pulse is applied at the input during EMC and Immunity testing.

For inrush control only during AC input voltage power-up, known method include use of a relay across an inrush control resistor arranged such that the relay contact is in series with the AC input voltage line. An example of this is the relay 41 connected across resistor 39 at the input in circuit 80 in FIG. 4. The relay contact must handle the entire input current for this known method. In high power applications, this forces use of a bigger and higher cost relay rated for a large current, making higher density packaging difficult. Moreover, the larger relays required for these known method are slow to react and have an undesirably large contact bounce. A lower cost and smaller relay can be used for inrush control only during AC input voltage power-up if the inrush control resistor and relay contact are placed in series with the bulk capacitor, as was done in FIG. 7A.

Alternatively, if active inrush control is not required, a simple logic circuit can cause the relay to turn on once the internal auxiliary converter (not shown) powers up. The relay contact can be disengaged after the desired hold-up period after the input AC fails. For this alternative circuit, the following precautions are required: the PFC DRIVE for switching of the boost converter can be enabled only after the relay contact is closed and the relay contact can be opened only when the PFC DRIVE for the boost converter is disabled and the boost inductor has been completedly discharged. FIG. 8 shows an exemplary circuit diagram of an alternative embodiment of the circuit of the present invention for providing inrush current control only during AC power up if active inrush control is not required.

The circuit 300 in FIG. 8 includes a bypass diode 348 connected in parallel with a boost converter 320 between a bridge rectifier 394 and the positive Bulk output voltage node terminal (Bulk +). The boost converter 320 is operatively connected between bridge rectifier 394 and a (bulk) capacitor 333. Boost converter 320 includes an inductor 352 and a diode 348, and a switch 398. The series combination of inductor 352 and diode 348 is coupled between bridge rectifier 394 and the Bulk+terminal. Switch 398 is connected between a node, intermediate to inductor 352 and diode 348, and the negative bulk output voltage node terminal. Switch 398 is preferably a MOSFET having a source, a drain and a control gate terminal. Switch 398 is controlled by application of a suitable waveform to its control gate terminal. The gate drive signal, preferably controlled for power factor correction, is provided for control of switch 398 of the boost converter 320. This gate drive signal is identified as “PFC DRIVE” in FIG. 6A. A suitable PFC control circuit may be used to provide the PFC Drive signal for achieving power factor correction (details not shown, PFC being well known to one of ordinary skill in the art).

The capacitor 333 is connected in series with a series combination of thermistor TH1 and thermistor TH2 across the DC bulk output voltage terminals. Thermistors are preferably used instead of fixed resistors for reducing cost and component size. A relay 310 is coupled in parallel with the series combination of thermistor TH1, and thermistor TH2 and in parallel with a diode 350. A relay drive circuit 330 provides a suitable control signal for switching the relay 310 on and off. A capacitor 360 is coupled across the DC bulk output voltage terminals.

The operation of the circuit 300 will now be described in further detail. Capacitor 333 charges in a controlled manner when AC power is applied to the power supply due to the series resistance of thermistors TH1 and TH2. Soon after initial power on, capacitor 333 charges to a suitable level causing an internal auxiliary converter (not shown) to start up and generate all internal bias supply to the circuit 300. Once the bias suppy is generated after capacitor 333 charges to a suitable level, the relay 310 is caused to turn on and power supply operation starts with PFC and then allowing a DC/DC converter (not shown) connected to the output of circuit 300 to turn on once the boost voltage stabilizes after entering the regulation band.

If a failure of the AC input occurs, the relay 310 is kept on during a predefined hold-up time of the power supply during the failure condition. After this predetermined hold up time, the PFC Drive is turned off and, after allowing the boost inductor 352 to discharge for a predetermined delay, about 50 to 100 microseconds, the relay 310 is turned off. Diode 350 in FIG. 8 provides a current path for the discharge of capacitor 333 when the relay 310 is opened. The operation of the inrush control in circuit 300 has similarities with the passive inrush current control using a relay as shown in FIG. 4. The main difference between the circuit 300 in FIG. 8 and the inrush control circuit in FIG. 4 is that the relay 310 in FIG. 8 is required to handle only bulk capacitor ripple current. As a result, circuit 300 enables use of a relay that is smaller and less costly than the relay 31 in FIG. 4.

FIG. 9 shows a circuit diagram of a preferred embodiment of a relay drive circuit according to the present invention. Referring to FIG. 7, the relay drive circuit 230 caused the relay 210 to turn on after a predetermined time delay, preferably 50 milliseconds, after detecting that the bulk output voltage is in regulation and stable. In operation, a resistor 402 and a resistor 404 are included for sensing the bulk voltage level (Bulk+). The voltage on resistor 404 is input to the negative input of a comparator 412. The output of comparator 412 is fedback to the positive input of comparator 412 via a series combination of a diode 410 and a resistor 408. A reference voltage, identified as “VREF” in FIG. 9, is coupled via a resistor 406 to the positive input of comparator 412. VREF is a predetermined voltage reference such that, when Bulk+is in regulation range, output of comparator 412 is caused to go low. A capacitor 420 discharges through a resistor 418 for setting the predetermined delay time, preferably 50 milliseconds. After this delay, the output of a comparator 426 goes high so as to cause the relay, e.g., relay 210 in FIG. 7A, to turn on.

During a missing line cycle or other power line disturbances, i.e., when the bulk voltage drops below a set threshold, the output of comparator 412 goes high so as to cause the relay drive to turn off the relay immediately. For an exemplary off line power supply, the bulk voltage is regulated at 400V. For this exemplary bulk voltage level, the turn on threshold of the relay is typically set at 400V and the turn off threshold is typically set at 380V. The turn on threshold, turn off threshold, and the time delay are predetermined for a particular application.

Having disclosed exemplary embodiments, modifications and variations may be made to the disclosed embodiments while remaining within the scope of the invention as described by the following claims.

What is claimed is:

1. An AC to DC power converter having active inrush current control during operational and power disturbance conditions, said converter having two input terminals to which AC power is coupled and two output terminals where the output DC power is provided, comprising:
an input rectifier for generating a rectified input voltage from a source of said AC power;
a boost converter coupled to said rectifier for converting said input voltage to a DC voltage, said boost converter having a first switch, an inductor, and a first diode;
an output capacitor connected to a first one of said DC output terminals;
a resistor connected in series between said output capacitor and a second one of said DC output terminals;
a second switch having a control input and being connected in parallel with said resistor;
a first control circuit operatively connected to said control input of said second switch for comparing the AC input and DC output voltages of said converter for causing said second switch to enter a conduction state when said AC input voltage exceeds a predetermined threshold and said AC input voltage is less than the DC output voltage;
a relay connected in parallel with said resistor and said second switch and having a control input; and
a second control circuit operatively connected to said control input of said relay for causing said relay to enter a conduction state to shunt said second switch and said resistor when the DC output voltage exceeds the peak of said AC input voltage for a predetermined time.

2. The converter of claim 1, further comprising a second diode connected in parallel with the series combination of said inductor and said first diode for preventing saturation of said inductor.

3. The converter of claim 1, wherein said control circuit further comprises a circuit for causing said second switch to be prevented from entering a conduction state.

4. The converter of claim 3, wherein said control circuit further includes a timing circuit for switching said first switch to an off state before said second switch is switched to the off state.

5. The converter of claim 4, wherein said timing circuit further includes logic for setting said first switch to an off state and holding said first switch in the off state until said second switch is triggered to the on state.

6. The converter of claim 1, wherein said second switch is a MOSFET, having a source, drain, gate and a body diode.

7. The converter of claim 1, wherein said rectifier is a diode bridge.

8. A method of controlling inrush current in a AC-DC converter when AC power is lost during power line disturbance conditions, wherein the AC to DC converter is coupled between two input terminals to which AC power is coupled and two output terminals where the DC output voltage is provided, the AC-to DC converter including a boost converter controlled by a first switch, the AC to DC converter having connected across the output terminals a capacitor connected in series with the combination of a limiting resistor connected in parallel with a second switch, and a relay having a control input and connected in parallel with said limiting resistor and said second switch, comprising the steps of:
a) Causing said first switch to be in an off state when said AC power is lost for a predetermined time interval;
b) Causing said relay to switch said relay contact to an open state a predetermined time after said first switch is switched to the off state,
c) Causing said second switch to be in an off state substantially simultaneously with the switching of said relay contact to the open state in step b);
d) Comparing the instantaneous AC input voltage to the DC output voltage of the converter;
e) Comparing the instantaneous AC input voltage to a predetermined voltage level to determine if the AC input voltage is present and non-zero;
f) Causing said second switch to be in an on state when said AC power is restored to said predetermined voltage level and the instantaneous input AC voltage is less than the DC voltage at the output of the AC-DC converter;
g) Causing said second switch to be in an off state when said AC power is restored to said predetermined voltage level and the instantaneous input AC voltage is greater than the DC voltage at the output of the AC-DC converter; and
h) Causing said relay to switch said relay contact to a closed state to shunt said second switch and said limiting resistor a predetermined time after said AC power is restored to said predetermined voltage level and the DC voltage at the output of the AC-DC converter is greater than the instantaneous input AC voltage, such that inrush current is controlled and voltage surges at said DC output terminals are eliminated.

9. The method of claim 8, wherein said predetermined time in step b) is for allowing said inductor to be discharged into said capacitor.

10. The method of claim 8, wherein the AC-DC converter includes a power factor control circuit for controlling said first switch of said boost converter.

11. The method of claim 8, comprising the further step of:
i) maintaining said first switch in an off state for a predetermined time after said second switch is switched to the on state.
